(19) United States
(12) Patent Application Publication
(10) Pub. No.: US 2010/0050420 A1
(43) Pub. Date: Mar. 4, 2010

(54) MAGNETIC ELEMENT AND MANUFACTURING METHOD THEREOF

(76) Inventors: Chung-Jung KUO, (US); Chieh-Cheng CHEN, (US); Yu-Lin HSUEH, (US); Chih-Hung CHANG, (US)

Correspondence Address: Muncy, Geissler, Olds & Lowe, PLLC, P.O. BOX 1364, FAIRFAX, VA, 22038-1364, US

(21) Appl. No.: 12/344,145

(22) Filed: Dec. 24, 2008

(30) Foreign Application Priority Data
Sep. 4, 2008 (TW) 097133841

(51) Int. Cl. H01F 7/06

(52) U.S. Cl. 29/607; 29/527.1; 336/221

(57) ABSTRACT

A manufacturing method of a magnetic element includes the steps of providing a first magnetic material, a second magnetic material, and at least one coil; disposing the coil in a mold; applying the first magnetic material in the coil to form a winding magnetic core; and applying the second magnetic material in the mold to form a magnetic body for covering the winding magnetic core.

### CROSS REFERENCE TO RELATED APPLICATIONS

This Non-provisional application claims priority under 35 U.S.C. §119(a) on Patent Application No(s). 097133841 filed in Taiwan, Republic of China on Sep. 4, 2008, the entire contents of which are hereby incorporated by reference.

### BACKGROUND OF THE INVENTION

1. Field of Invention

The present invention relates to a magnetic element and a manufacturing method thereof. More particularly, the present invention relates to a closed magnetic element, which has high operating efficiency and low magnetic loss and is small-sized and automatized so as to increase the throughput, and a manufacturing method thereof.

2. Related Art

Accompanying the progressive of technology, the electronic products tend to have a small size, low operating voltage, and high operating current. The important basic part such as the magnetic element also needs to reduce its weight and size for the element minimization.

FIG. 1 shows a conventional magnetic element. Referring to FIG. 1, while the magnetic element is forming, the magnetic core 11 wound by the coil 12 is attached to the magnetic sleeve 13 by gluing for covering the magnetic core 11 so as to prevent the magnetic leakage. Because of the difference of thermal expansion coefficients on the gluing interface, a thermal stress is generated so as to separate the magnetic core 11 wound by the coil 12 and the magnetic sleeve 13 under the high temperature usage or the high-temperature-high-humidity reliability test. Also because the glue is easily decomposed, the magnetic core 11 wound around the coil and the magnetic sleeve 13 can easily be separated once they are forced or shaken. Moreover, the amount of glue used for attaching is hard to control and the glue might overflow. This could cause the variation in product size or contamination of the magnetic core.

Thus, the conventional invention is not only easily affected by the outside environment hence causing the damage to the product but also confined by the technical bottleneck so that a further minimization and automatization cannot be implemented. Therefore, the product cannot fit the trend of lighter and more corn pact.

### SUMMARY OF THE INVENTION

In view of the foregoing, the present invention is to provide a closed magnetic element and its manufacturing method. The closed magnetic element has high operating efficiency and low magnetic loss, and is small-sized and automatized, and the manufacturing method can increase the throughput.

To achieve the above, the present invention discloses a manufacturing method of a magnetic element including the steps of providing a first magnetic material, a second magnetic material and at least one coil; disposing the coil in a mold; applying the first magnetic material in the coil by a first means to form a winding magnetic core; and applying the second magnetic material in the mold by a second means to form a magnetic body that covers the winding magnetic core.

The first means is an injection molding method, the first magnetic material is a magnetic plastic, the second means is a press molding method, and the second magnetic material is a magnetic powder. Alternatively, the first means is a press molding method, the first magnetic material is a magnetic powder, the second means is an injection molding method, and the second magnetic material is a magnetic plastic.

The above-mentioned magnetic plastic preferably includes a metal containing iron (Fe), cobalt (Co), nickel (Ni), or their alloy, and mixing with a ferrite powder and a thermoplastic or thermosetting resin. The above-mentioned magnetic powder is preferably a metal containing Fe, Co, Ni, or their alloy, and mixing with a ferrite powder and a thermosetting resin.

Before the first magnetic material is applied in the coil by the first means, the manufacturing method further includes a step of positioning the coil and the mold. After the first magnetic material is applied in the coil by the first means, or after the second magnetic material is applied in the mold by the second means, the manufacturing method further includes a step of solidifying the first magnetic material or the second magnetic material.

When the first magnetic material or the second magnetic material includes the thermoplastic resin, the first magnetic material or the second magnetic material can be cooled down and solidified. When the first magnetic material or the second magnetic material includes the thermosetting resin, the first magnetic material or the second magnetic material can be heated up and solidified.

The thermoplastic resin preferably is polypropylene, polyphenylene sulfide (PPS), nylon 6, nylon 21, or nylon 66. The thermosetting resin preferably is epoxy resin, phenol, aldehyde, silicon resin, unsaturated polyester, or polyimide. The coil is formed by winding the round-shaped, square-shaped, or flat-shaped wire.

At least one end of the coil is used directly as a pin or is connected to a conducting structure as a pin. The end of the coil or the conducting structure is protruded to the outside of the magnetic body. After the second magnetic material is applied in the mold, the manufacturing method further includes a step of performing a cutting action for cutting the end of the coil or the conducting structure.

To achieve the above, the present invention further provides a manufacturing method of a magnetic element including the steps of providing a magnetic core, winding at least one coil on the surface of the magnetic core to form a winding magnetic core, disposing the winding magnetic core in a mold, and applying a magnetic material in the mold by a molding method to form a magnetic body, which covers the winding magnetic core.

To achieve the above, the present invention further provides a magnetic element including a coil and at least one magnetic body. The magnetic body covers the coil by injection or press molding.

As described above, in the magnetic element and its manufacturing method of the present invention, the magnetic plastic is injected or pressed to the mold, and the magnetic body is formed by covering, containing, and positioning the coil in the mold so as to complete the manufacture of the magnetic element. Therefore, through the easy implementation of the injection or press molding technique, a better magnetic element with reduced size can be made. Also with the design of the mold, the magnetic elements can be mass produced and this will shorten the manufacture time.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional magnetic element;

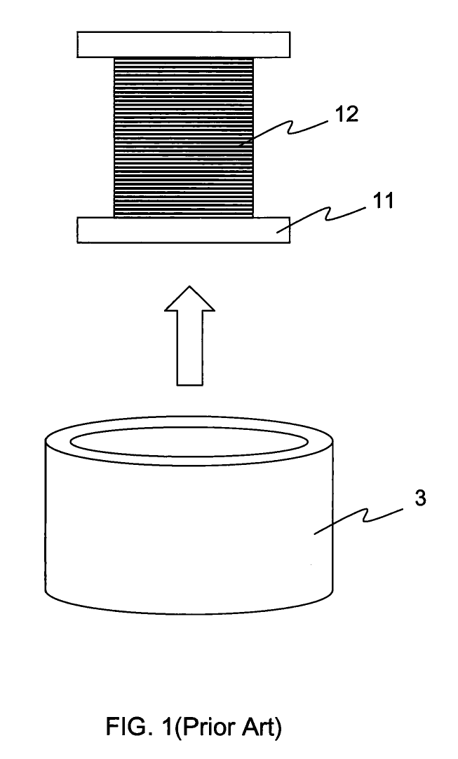

FIG. 2 is a flow chart showing the steps of a manufacturing method of a magnetic element according to a preferred embodiment of the present invention;

FIG. 3 is a flow chart showing the steps of another manufacturing method of a magnetic element according to the preferred embodiment of the present invention;

FIG. 4 is a flow chart showing the steps of yet another manufacturing method of a magnetic element according to the preferred embodiment of the present invention;

FIG. 5 is a schematic view of a mold and a device for manufacturing the magnetic element according to the preferred embodiment of the present invention; and

FIG. 6 is a schematic view of a magnetic element according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

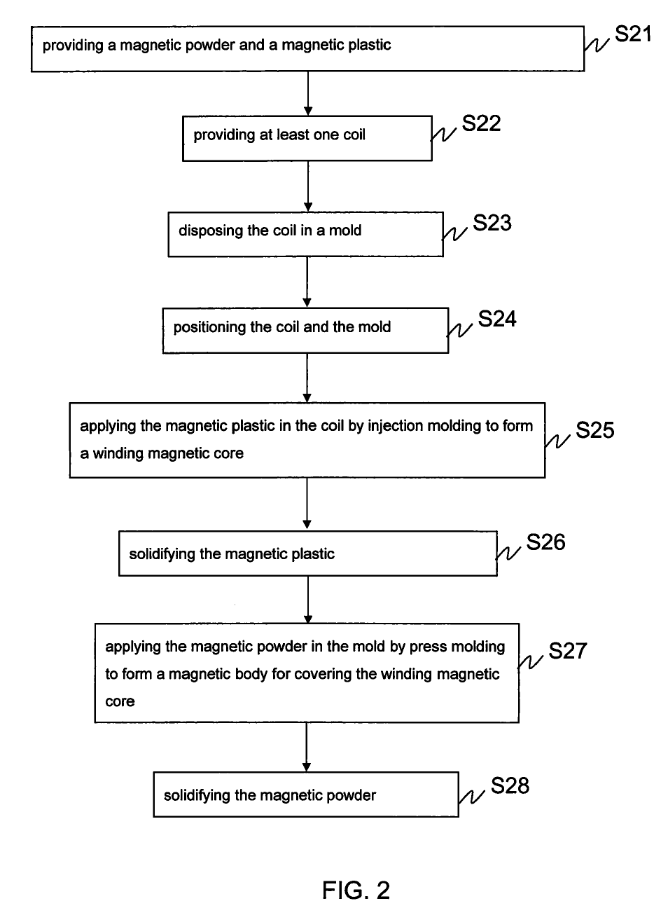

FIG. 2 is a flow chart showing the steps of a manufacturing method of a magnetic element according to a preferred embodiment of the present invention. Referring to FIG. 2, the manufacturing method of a magnetic element includes the steps as follow:

Step S21: providing a magnetic plastic and a magnetic powder;

Step S22: providing at least one coil;

Step S23: disposing the coil in a mold;

Step S24: positioning the coil and the mold;

Step S25: applying the magnetic plastic in the coil by injection molding to form a winding magnetic core;

Step S26: solidifying the magnetic plastic;

Step S27: applying the magnetic powder in the mold by press molding to form a magnetic body for covering the winding magnetic core; and

Step S28: solidifying the magnetic powder.

The magnetic plastic is preferably a metal containing iron, cobalt, or nickel, or their alloy, mixing with a ferrite powder and a thermoplastic or thermosetting resin. The magnetic powder is preferably a metal containing iron, cobalt, or nickel, or their alloy, mixing with a ferrite powder and a thermosetting resin.

As the magnetic plastic or the magnetic powder includes the thermoplastic resin, the magnetic plastic or the magnetic powder is cooled down and solidified. As the magnetic plastic or the magnetic powder includes the thermosetting resin, the magnetic plastic or the magnetic powder is heated up and solidified.

The thermoplastic resin is preferably polypropylene, polyphenylene sulfide (PPS), nylon 6, nylon 21, or nylon 66. The thermosetting resin is preferably epoxy resin, phenol, aldehyde, silicon resin, unsaturated polyester, or polyimide. The coil is formed by winding the round-shaped, square-shaped, or flat-shaped wire.

At least one end of the coil is directly used as a pin or is connected to a conducting structure as a pin. The end of the coil or the conducting structure is protruded to the outside of the magnetic body. After the magnetic powder is applying in the mold to form the magnetic body, the manufacturing method further includes a step of performing a cutting action for cutting the end of the coil or the conducting structure.

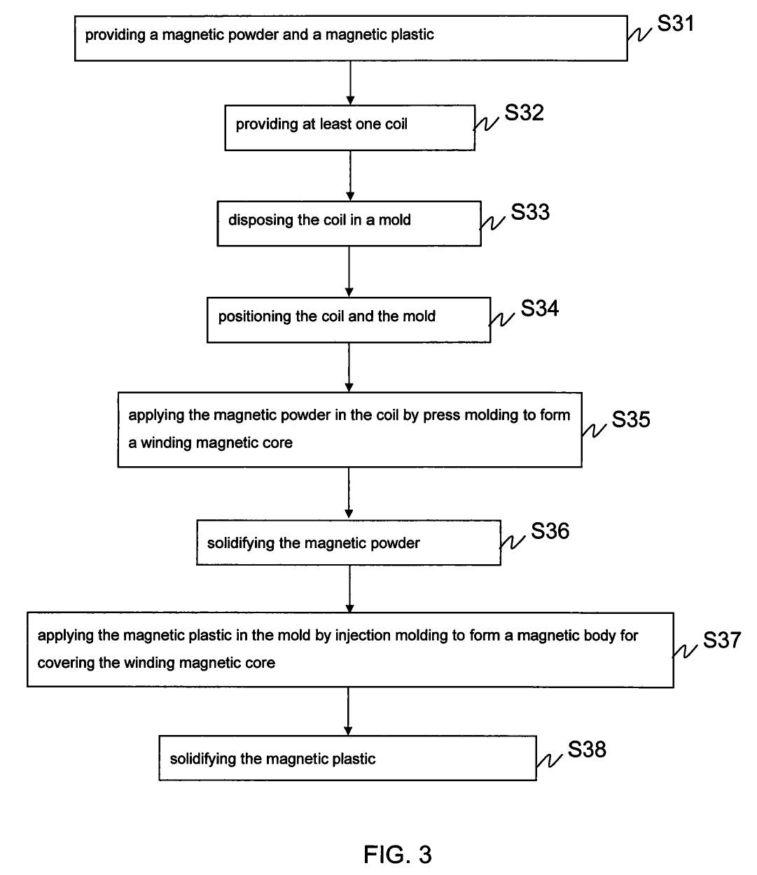

FIG. 3 is a flow chart showing the steps of another manufacturing method of a magnetic element according to the preferred embodiment of the present invention. The difference between FIG. 3 and FIG. 2 is that in step S35, the magnetic powder is applied in the coil by press molding to form the winding magnetic core, and in step S36, the magnetic powder is solidified. And then in step S37, the magnetic plastic is applied in the mold by injection molding to form the magnetic body, and in step S38, the magnetic plastic used to form the magnetic body is solidified.

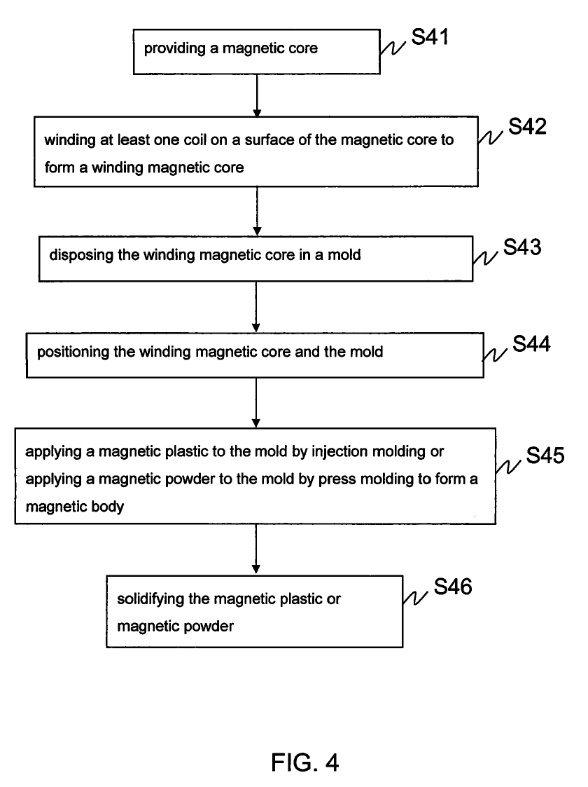

FIG. 4 is a flow chart showing the steps of yet another manufacturing method of a magnetic element according to the preferred embodiment of the present invention. The different between FIG. 4 and FIGS. 2 and 3 is that in step S41, a magnetic core is provided, in step S42, at least one coil is wound around the surface of the magnetic core to form a winding magnetic core, and then in step S45, the magnetic body is formed by injection molding or press molding, so that the magnetic element is manufactured.

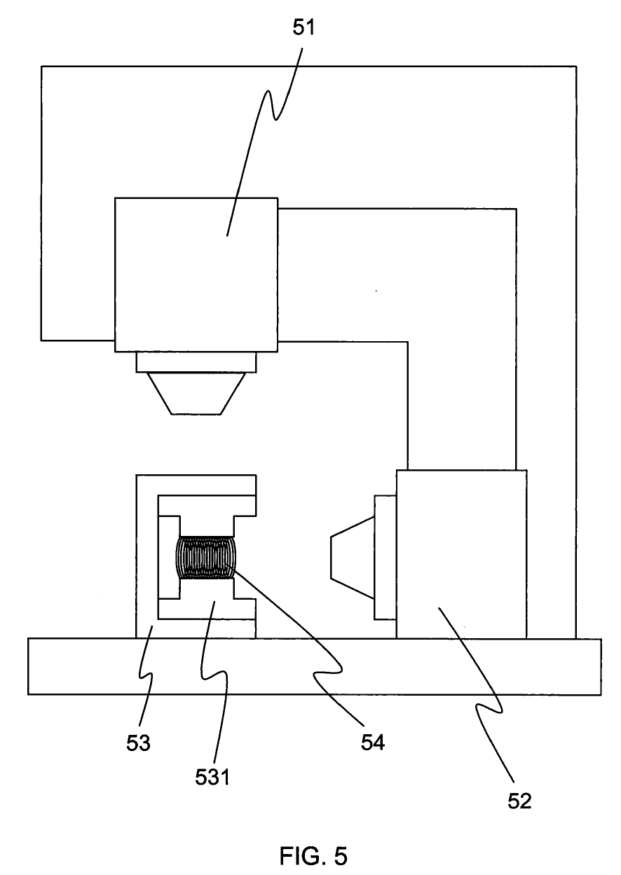

FIG. 5 is a schematic view of a mold and a device for manufacturing the magnetic element according to the preferred embodiment of the present invention. With reference to FIG. 5, an injection device 52, a pressure control device 51, a coil 54, and a mold 53 are disclosed for manufacture. The injection device 52 and the pressure control device 51 are disposed perpendicular to each other on the same machine. The coil 54 is disposed in the mold 53 and is positioned in the mold 53 by a mold element 53 1. The opening of the mold 53 horizontally faces the injection device 52. After the injection device 52 injects the magnetic plastic into the coil 54 to form a winding magnetic core, the mold 53 is rotated 90 degrees counterclockwise so that the opening is rotated to face the pressure control device 5 1. Then the mold element 531 is removed from the mold 53, and the magnetic powder is pressed into the mold 53 and covers the winding magnetic core to form a magnetic body.

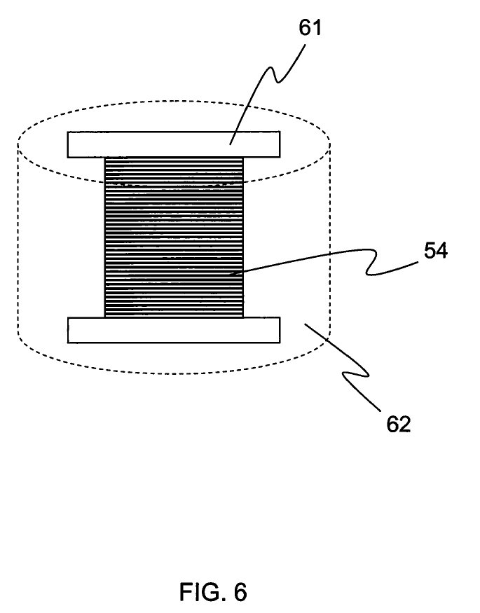

With reference to FIG. 6, the magnetic element of the present invention includes a magnetic core 61, at least one coil 54, and at least one magnetic body 62. The magnetic core 61 is made of a first magnetic material, and the coil 54 is wound around the surface of the first magnetic material. The magnetic body 62 made of a second magnetic material is integrally formed and covers the coil 54 and the magnetic core 61. The first magnetic material and the second magnetic material can be a magnetic plastic or a magnetic powder.

To sum up, in the magnetic element and its manufacturing method of the present invention, the magnetic plastic is injected or pressed into the mold to cover, contain, and position the coil in the mold so as to form the magnetic body, thereby completing the manufacture of the magnetic element. Therefore, through the easy implementation of the injection or press molding technique, a better magnetic element with reduced size can be made. Also with the design of the mold, the magnetic elements can be mass produced and this will shorten the manufacture time.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of a magnetic element comprising the steps of:
providing a first magnetic material and a second magnetic material;
providing at least one coil;
disposing the coil in a mold;
applying the first magnetic material in the coil to form a winding magnetic core; and
applying the second magnetic material in the mold to form a magnetic body for covering the winding magnetic core.

2. The manufacturing method according to claim 1, wherein the winding magnetic core is formed by injection molding the first magnetic material in the coil, and the magnetic body is formed by press molding the second magnetic material.

3. The manufacturing method according to claim 1, wherein the winding magnetic coil is formed by press molding the first magnetic material in the coil, and the magnetic body is formed by injection molding the second magnetic material.

4. The manufacturing method according to claim 1, wherein the winding magnetic coil and the magnetic body are formed by injection molding or press molding, the injection molding is implemented by an injection device, and the press molding is implemented by a pressure control device.

5. The manufacturing method according to claim 4, wherein the injection device and the pressure control device are disposed on the same machine.

6. The manufacturing method according to claim 1, wherein the first magnetic material and the second magnetic material are magnetic powder or magnetic plastic, respectively.

7. The manufacturing method according to claim 6, wherein the magnetic plastic or the magnetic powder comprises Fe, Co, Ni, a metal, an alloy, a ferrite powder, a thermoplastic resin or a thermosetting resin, wherein the thermoplastic resin is polypropylene, polyphenylene sulfide (PPS) or nylon, and the thermosetting resin is epoxy resin, phenol, aldehyde, silicon resin, unsaturated polyester or polyimide, wherein the nylon is nylon 6, nylon 21 or nylon 66.

8. The manufacturing method according to claim 1, wherein before the step of applying the first magnetic material in the coil, the manufacturing method further comprises a step of positioning the coil and the mold.

9. The manufacturing method according to claim 1, wherein before the step of applying the second magnetic material in the mold, the manufacturing method further comprises a step of positioning the winding magnetic core and the mold.

10. The manufacturing method according to claim 1, wherein after the step of applying the first magnetic material in the coil, the manufacturing method further comprises a step of rotating or moving the mold.

11. The manufacturing method according to claim 1, wherein after the step of applying the first magnetic material in the coil or after the step of applying the second magnetic material in the mold, the manufacturing method further comprises a step of solidifying the first magnetic material or the second magnetic material.

12. The manufacturing method according to claim 11, wherein when the first magnetic material or the second magnetic material comprises a thermoplastic resin, the first magnetic material or the second magnetic material is cooled down to be solidified; when the first magnetic material or the second magnetic material comprises a thermosetting resin, the first magnetic material or the second magnetic material is heated up to be solidified.

13. The manufacturing method according to claim 1, wherein the mold further comprises a mold element for positioning the coil, and after the first magnetic material is applied in the coil to form the winding magnetic core, the mold element is removed.

14. The manufacturing method according to claim 1, wherein at least one end of the coil is used directly as a pin or is connected to at least one conducting structure as a pin, and the end of the coil or the conducting structure is protruded out of the magnetic body.

15. The manufacturing method according to claim 14, wherein after the step of forming the magnetic body, the manufacturing method further comprises a step of performing a cutting action for cutting the end of the coil or the conducting structure.

16. A manufacturing method of a magnetic element comprising the steps of:
providing a magnetic core;
winding at least one coil on the magnetic core to form a winding magnetic core;
disposing the winding magnetic core in a mold; and
applying a magnetic material to the mold to form a magnetic body, wherein the magnetic body covers the winding magnetic core.

17. The manufacturing method according to claim 16, wherein the magnetic body is formed by injection molding or press molding.

18. The manufacturing method according to claim 16, wherein the magnetic material is a magnetic plastic or a magnetic powder.

19. A magnetic element comprising:
a magnetic core comprising a first magnetic material;
at least one coil winding around the magnetic core; and
at least one magnetic body comprising a second magnetic material and covering the coil and the magnetic core.

20. The magnetic element according to claim 19, wherein the first magnetic material and the second magnetic material are magnetic powder or magnetic plastic, respectively.

21. The magnetic element according to claim 19, wherein at least one end of the coil is used directly as a pin or is connected to at least one conducting structure as a pin, and the end of the coil or the conducting structure is protruded to the outside of the magnetic body.
